(19) United States
(12) Patent Application Publication
(10) Pub. No.: US 2025/0333940 A1
(43) Pub. Date: Oct. 30, 2025

(54) SLIDING SEAT AND SHOWER HEAD ASSEMBLY

(71) Applicant: SINYU TECHNOLOGY (FUJIAN) CO., LTD., Fujian (CN)

(72) Inventors: Zhangjun YU, Fujian (CN); Huasheng PENG, Fujian (CN); Longbin XIONG, Fujian (CN)

(73) Assignee: SINYU TECHNOLOGY (FUJIAN) CO., LTD., Fujian (CN)

(21) Appl. No.: 18/816,386

(22) Filed: Aug. 27, 2024

(30) Foreign Application Priority Data
Apr. 25, 2024 (CN) 2024208795434

(51) Int. Cl. E03C 1/06; B05B 1/18

(52) U.S. Cl. CPC E03C 1/063; E03C 1/066; B05B 1/18

(57) ABSTRACT

Provided are sliding seat and shower head assembly, wherein the sliding seat includes main body, locking part, elastic member, and triggering part. The main body is provided with an accommodating cavity that penetrates in first direction, wherein the accommodating cavity is provided with an access opening arranged in second direction. The access opening allows structural component to enter and exit the accommodating cavity. The locking part is arranged in the accommodating cavity in movable manner. The elastic member is arranged on the main body and connected to the locking part. The elastic member is configured to provide elastic force to the locking part so that the locking part abuts the structural component in third direction to lock the structural component in the accommodating cavity. The first direction, the second direction, and the third direction are mutually perpendicular to each other. The triggering part is connected to the locking part.

### CROSS-REFERENCE TO RELATED APPLICATION

The present disclosure claims the priority to the Chinese patent application with the publication No. 2024208795434 filed with the Chinese Patent Office on Apr. 25, 2024, and entitled “SLIDING SEAT AND SHOWER HEAD ASSEMBLY”, the contents of which are incorporated herein by reference in entirety.

### TECHNICAL FIELD

The present disclosure relates to the technical field of kitchen and bathroom products, and particularly to a sliding seat and a shower head assembly.

### BACKGROUND ART

A sliding seat configured for fixing the shower head is provided on the lifting rod, shower column, or fixed pipe. The sliding seat can slide up and down along the lifting rod, shower column, or fixed pipe to flexibly adjust the height of the shower head.

Usually, the middle of the sliding seat is provided with a sleeve hole for the lifting rod, shower column, or fixed pipe to pass through. When mounting, the sliding seat is first sleeved over the end portion of the lifting rod, shower column, or fixed pipe. After that, the lifting rod or shower column can be locked to the wall with the help of a fixing seat.

Therefore, the replacement of the sliding seat is inconvenient and labor-intensive.

### SUMMARY

The present disclosure provides a sliding seat, wherein the sliding seat includes a main body, a locking part, an elastic member, and a triggering part. The main body is provided with an accommodating cavity that penetrates in a first direction, wherein the accommodating cavity is provided with an access opening arranged in a second direction. The access opening allows a structural component to enter and exit the accommodating cavity. The locking part is arranged in the accommodating cavity in a movable manner. The elastic member is arranged on the main body and connected to the locking part. The elastic member is configured to provide elastic force to the locking part so that the locking part abuts the structural component in a third direction to lock the structural component in the accommodating cavity. The first direction, the second direction, and the third direction are mutually perpendicular to each other. The triggering part is connected to the locking part. A portion of the triggering part is located outside the main body, wherein the portion of the triggering part located outside the main body is configured to be triggered so that the locking part overcomes the elastic force and cancels the locking for the structural component.

The present disclosure further provides a shower head assembly, including a fixed pipe, a shower head, and the sliding seat provided in the first aspect. The fixed pipe is located in the accommodating cavity, the sliding seat is fixed to the fixed pipe through the locking part, and the shower head is mounted on the sliding seat.

### BRIEF DESCRIPTION OF DRAWINGS

In order to more clearly illustrate the technical solutions of the embodiments of the present disclosure, the following will briefly introduce the drawings used in the embodiments. It should be understood that the following drawings only show some embodiments of the present disclosure, and therefore it should not be regarded as a limitation on the scope. Those ordinary skilled in the art can also obtain other related drawings based on these drawings without inventive effort.

FIG. 1 is a three-dimensional view of a sliding seat in some embodiments of the present disclosure;

FIG. 2 is a three-dimensional exploded view of the sliding seat in some embodiments of the present disclosure;

FIG. 3 is a schematic view of an internal structure of the sliding seat in some embodiments of the present disclosure; and

FIG. 4 is a schematic view of the sliding seat, a fixed pipe, and a shower head in some embodiments of the present disclosure.

Reference numerals: 100—shower head assembly; 10—sliding seat; 20—fixed pipe; 30—shower head;
11—main body; 110—accommodating cavity; 1100—access opening; 111—sliding groove; 1110—limiting block; 1111—projection; 12—locking part; 120—sliding rod; 1200—rod body; 1201—slider; 1202—groove; 1203—connecting piece; 121—abutting piece; 13—elastic member; 14—triggering part; 15—fitting part; 16—bracket set; 17—hanging-mounting hole; 18—housing; z—first direction; x—second direction; y—third direction.

### DETAILED DESCRIPTION OF EMBODIMENTS

In order to make the objectives, technical solutions, and advantages of the embodiments of the present disclosure clearer, the technical solutions in the embodiments of the present disclosure will be clearly and completely described below in conjunction with the drawings in the embodiments of the present disclosure. It is evident that the described embodiments are part of the embodiments of the present disclosure, but not all of the embodiments. The components of the embodiments of the present disclosure described and illustrated in the drawings can typically be arranged and designed in various configurations.

Therefore, the following detailed description of the embodiments of the present disclosure provided in the drawings is not intended to limit the scope of the present disclosure for which protection is claimed but merely represents selected embodiments of the present disclosure. Based on the embodiments of the present disclosure, all other embodiments obtained by those skilled in the art without inventive effort shall fall within the scope of protection of the present disclosure.

It should be noted that similar numerals and letters denote similar terms in the following drawings so that once an item is defined in one drawing, it does not need to be further discussed in subsequent drawings.

In the description of the embodiments of the present disclosure, it is to be understood that terms such as “center”, “upper”, “lower”, “left”, “right”, “vertical”, “horizontal”, “inner”, “outer” and the like indicating orientations or positional relationships are based on the orientations or positional relationships shown in the drawings, or the customary orientations or positional relationships when the disclosed products are used, or the orientations or positional relationships as conventionally understood by those skilled in the art. These terms are merely for convenience of description and simplification of the disclosure, rather than indicating or implying that the referred-to devices or elements must have specific orientations or be constructed and operated in specific orientations. Therefore, they should not be understood as limitations to the present disclosure.

In the description of the embodiments of the present disclosure, it should also be noted that, unless otherwise explicitly specified and defined, the terms “arrange”, “mount”, “link” and “connect” should be interpreted broadly. For example, they may refer to fixed connections, detachable connections, or integral connections; they may be directly connected or indirectly connected through an intermediary; they may refer to the communication between the interiors of two elements. Those of ordinary skill in the art can understand the meanings of the above terms in the present disclosure according to specific situations.

It should be noted that, where there is no conflict, the embodiments and features in the embodiments of the present disclosure can be combined with each other.

The present disclosure provides a sliding seat and a shower head assembly. The technical solution provided by the present disclosure allows for convenient disassembly of the sliding seat and strong adaptability.

In a first aspect, the present disclosure provides a sliding seat, wherein the sliding seat includes a main body, a locking part, an elastic member, and a triggering part. The main body is provided with an accommodating cavity that penetrates in a first direction, wherein the accommodating cavity is provided with an access opening arranged in a second direction. The access opening allows a structural component to enter and exit the accommodating cavity. The locking part is arranged in the accommodating cavity in a movable manner. The elastic member is arranged on the main body and connected to the locking part. The elastic member is configured to provide elastic force to the locking part so that the locking part abuts the structural component in a third direction to lock the structural component in the accommodating cavity. The first direction, the second direction, and the third direction are mutually perpendicular to each other. The triggering part is connected to the locking part. A portion of the triggering part is located outside the main body, wherein the portion of the triggering part located outside the main body is configured to be triggered so that the locking part overcomes the elastic force and cancels the locking for the structural component.

In the above solution, on one hand, the elastic force provided by the elastic member allows the locking part to abut a portion of the structural component (e.g., fixed pipe) located in the accommodating cavity so as to lock the structural component in the accommodating cavity, thus achieving relative fixation between the sliding seat and the structural component and enabling adaptation to structural components of different sizes. On the other hand, by arranging the triggering part and arranging a portion of the triggering part outside the main body, the user can trigger the triggering part from outside the main body to unlock the locking part, thereby enabling quick separation of the sliding seat from the structural component. Exemplarily, when the structural component is a fixed pipe, by arranging the elastic member and the triggering part, on one hand, the sliding seat can be quickly mounted on the fixed pipe and can adapt to fixed pipes of different sizes. On the other hand, the sliding seat can be quickly and conveniently removed from the fixed pipe.

According to some embodiments of the present disclosure, the main body is provided with a fitting part, wherein the fitting part is arranged in the accommodating cavity. The locking part is oppositely arranged to the fitting part along the third direction. The locking part is configured to move toward the fitting part under the action of the elastic force, so as to jointly clamp the structural component with the fitting part.

In the above solution, by arranging the fitting part, the locking part is enabled to move in one direction under the action of the elastic member so as to jointly clamp the structural component with the fitting part. On one hand, this allows the structural component to be stably locked in the accommodating cavity, thus ensuring a stable relative positional relationship between the sliding seat and the structural component. On the other hand, since the locking part moves in one direction, the locking structure of the sliding seat for the structural component is simple, which can reduce the failure rate of the sliding seat and improve the operational stability of the sliding seat.

According to some embodiments of the present disclosure, the locking part is positioned between the triggering part and the fitting part along the third direction. The triggering part includes a pull knob, wherein a portion of the pull knob is located inside the main body to connect the locking part and another portion of the pull knob is located outside the main body, which is configured to pull the locking part away from the fitting part.

In the above solution, by arranging the locking part between the triggering part and the fitting part, and arranging the triggering part to be included with a pull knob, the locking part can be conveniently pulled away from the fitting part by pulling the pull knob, thereby canceling the lock on the structural component and improving the efficiency of separating the sliding seat from the structural component.

According to some embodiments of the present disclosure, a sliding groove is formed inside the main body, wherein the sliding groove communicates with the accommodating cavity. The locking part includes a sliding rod and an abutting piece, wherein the triggering part is connected to the sliding rod and the sliding rod fits with the sliding groove along the third direction in a slidable manner. An end portion of the sliding rod along the third direction is connected to the abutting piece. The abutting piece is configured to abut the structural component.

In the above solution, through the mutual cooperation of the sliding rod and the sliding groove, the locking part can stably move along the third direction, so that the abutting piece can stably abut against or move away from the structural component. Thus, locking and unlocking of the structural component is performed stably, making the sliding seat highly reliable.

According to some embodiments of the present disclosure, the sliding rod includes a rod body and a slider, wherein the slider is arranged on the outer periphery of the rod body and the slider is in sliding fit with the sliding groove. The groove wall of the sliding groove is provided with a limiting block in a protruding manner. Along the third direction, the limiting block is configured to contact the slider to prevent the sliding rod from coming out of the sliding groove.

In the above solution, by providing a limiting block on the sliding groove in a protruding manner to fit with the slider, the sliding rod can be prevented from coming out of the sliding groove due to excessive movement. This results in high locking stability of the locking part, high reliability of the sliding seat, and stable connection between the sliding seat and the structural component.

According to some embodiments of the present disclosure, along the third direction, the end surface of the sliding rod away from the fitting part is provided with a groove. The groove wall of the sliding groove facing the sliding rod is provided with a projection. The elastic member includes a spring, wherein one end of the spring is sleeved on the projection, and the other end is accommodated in the groove.

In the above solution, by providing a groove on the end surface of the sliding rod away from the fitting part and arranging a projection on the groove wall of the sliding groove facing the sliding rod, the elastic member can stably provide elastic force along the third direction to the sliding rod. This results in high locking stability of the locking part, high reliability of the sliding seat, and stable connection between the sliding seat and the structural component.

According to some embodiments of the present disclosure, along the third direction, the bottom of the groove is provided with a connecting piece, wherein the triggering part passes through the wall portion of the main body and is in a threaded fit with the connecting piece.

In the above solution, by providing a connecting piece at the bottom of the groove, on the one hand, the difficulty of assembling the triggering part and the locking part can be reduced, thus improving the manufacturing efficiency of the sliding seat. On the other hand, the connection part of the triggering part and the locking part can be hidden in the groove, thereby reducing the impact of external substances on the connection part of the triggering part and the locking part and making the appearance of the sliding seat tidy.

According to some embodiments of the present disclosure, the abutting piece and the fitting part are friction pads, respectively.

In the above solution, by providing friction pads, the sliding seat can be stably mounted on the structural component, thereby reducing the risk of the sliding seat sliding or detaching from the structural component due to impact.

According to some embodiments of the present disclosure, the sliding seat further includes a bracket set, wherein along the third direction, the bracket set is arranged at the end portion of the main body. The bracket set is provided with a hanging-mounting hole, wherein the hanging-mounting hole is configured for hanging and mounting workpieces.

In the above solution, by providing the bracket set, workpieces can be hung. Exemplarily, the workpiece is a shower head. By providing the bracket set, the shower head can be mounted on the sliding seat.

In a second aspect, some embodiments of the present disclosure further provide a shower head assembly, including a fixed pipe, a shower head, and the sliding seat provided in the first aspect. The fixed pipe is located in the accommodating cavity, the sliding seat is fixed to the fixed pipe through the locking part, and the shower head is mounted on the sliding seat.

In the above solution, a shower head assembly is provided. The fixed pipe can be fixed to the wall, and the shower head is mounted on the sliding seat. The sliding seat can be stably mounted on the fixed pipe through the cooperation of the locking part and the elastic member, which can also adapt to fixed pipes of different sizes. At the same time, the sliding seat is able to overcome the elastic force of the elastic member by the triggering part, so as to quickly and easily remove the sliding seat from the fixed pipe.

In order to make the above objectives, features, and advantages of the present disclosure more apparent and understandable, the technical solutions of the present disclosure will be described below in conjunction with the drawings.

The embodiment provides a sliding seat 10, wherein the sliding seat 10 is configured to mount a workpiece on a structural component. Moreover, the sliding seat 10 can adjust the positional relationship between the workpiece and the structural component. In some embodiments, the structural component includes a rod, column, or other structural components. The workpiece includes a shower head. Exemplarily, the shower head is mounted on the sliding seat. The sliding seat is fixed on a lifting rod, shower column, or fixed pipe. The sliding seat can slide up and down along the lifting rod, shower column, or fixed pipe to flexibly adjust the height of the shower head.

In some embodiments of the present disclosure, the structural component as a fixed pipe fixed to the wall is taken as an example for illustration.

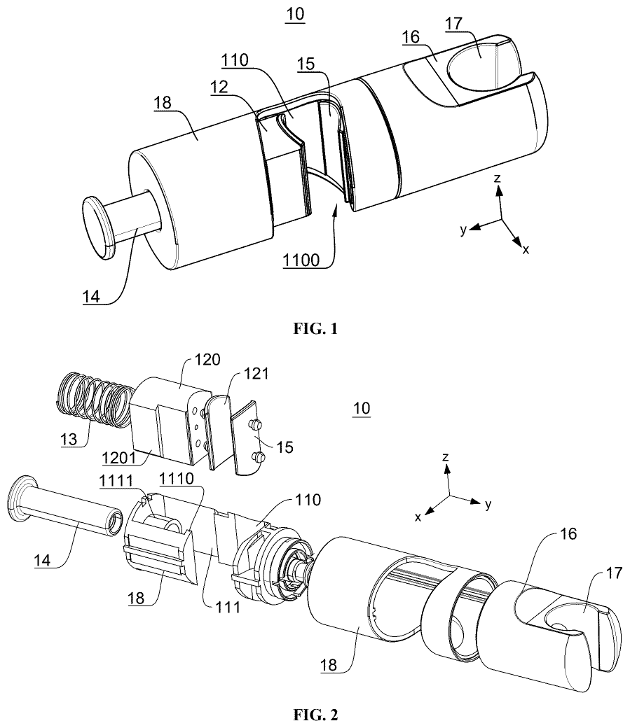

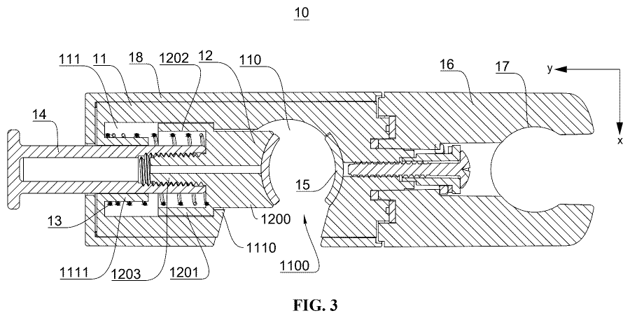

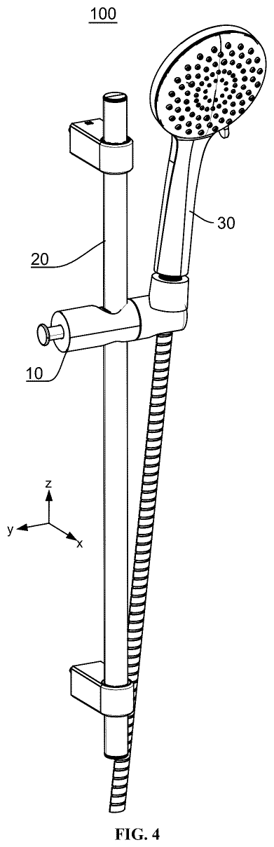

Referring to FIGS. 1-4, FIG. 1 is a three-dimensional view of a sliding seat in some embodiments of the present disclosure; FIG. 2 is a three-dimensional exploded view of the sliding seat in some embodiments of the present disclosure; FIG. 3 is a schematic view of an internal structure of the sliding seat in some embodiments of the present disclosure; and FIG. 4 is a schematic view of the sliding seat, a fixed pipe, and a shower head in some embodiments of the present disclosure.

The sliding seat 10 includes a main body 11, a locking part 12, an elastic member 13, and a triggering part 14. The main body 11 is provided with an accommodating cavity 110 that penetrates in a first direction z, wherein the accommodating cavity 110 is provided with an access opening 1100 arranged in a second direction x. The access opening 1100 allows the fixed pipe 20 to enter and exit the accommodating cavity 110. The locking part 12 is arranged in the accommodating cavity 110 in a movable manner. The elastic member 13 is arranged on the main body 11 and connected to the locking part 12. The elastic member 13 is configured to provide elastic force to the locking part 12 so that the locking part 12 abuts the fixed pipe 20 in a third direction y to lock the fixed pipe 20 in the accommodating cavity 110. The first direction z, the second direction x, and the third direction y are mutually perpendicular to each other. The triggering part 14 is connected to the locking part 12. A portion of the triggering part 14 is located outside the main body 11, wherein the portion of the triggering part 14 located outside the main body 11 is configured to be triggered so that the locking part 12 overcomes the elastic force and cancels the locking for the fixed pipe 20.

In some embodiments, the first direction z can be a vertical direction, the second direction x can be a forward-and-backward direction, and the third direction y can be a left-and-right direction.

In some embodiments, the main body 11 is the main component of the sliding seat 10. The main body 11 is provided with an accommodating cavity 110, wherein the accommodating cavity 110 is a portion configured for holding the fixed pipe 20. The accommodating cavity 110 penetrates in the first direction z, thus allowing the sliding seat 10 to slide relative to the fixed pipe 20 along the first direction z. The accommodating cavity 110 is provided with an opening arranged in the second direction x, thus enabling the sliding seat 10 to detach from the fixed pipe 20 along the second direction x or accommodate the fixed pipe 20 in the accommodating cavity 110.

In some embodiments, the shower head 30 can be arranged at the end portion of the main body 11, thereby allowing the shower head 30 to be fixed to the fixed pipe 20 through the sliding seat 10. In some embodiments, one end of the main body 11 in the third direction y is provided with a bracket set 16, wherein the bracket set 16 is provided with a hanging-mounting hole 17. The hanging-mounting hole 17 penetrates in the first direction z to hang the shower head 30.

The locking part 12 is a component arranged in the accommodating cavity 110 in a movable manner. The locking part 12 is configured to lock the fixed pipe 20 and the main body 11 together, thus keeping the fixed pipe 20 and the main body 11 stationary relative to each other. Exemplarily, through the action of the locking part 12, the shower head 30 can be fixed in position relative to the fixed pipe 20, thus providing the user with a shower at a suitable height.

In some embodiments, the locking part 12 can provide an abutting force for the fixed pipe 20 in the accommodating cavity 110, thus ensuring that the fixed pipe 20 remains stationary relative to the main body 11 under the action of the abutting force. The abutting force can be a unidirectional force along the third direction y. In some other embodiments, the locking part 12 can provide a clamping force for the fixed pipe 20 in the accommodating cavity 110, thus ensuring that the fixed pipe 20 remains stationary relative to the main body 11 under the action of the clamping force. The clamping force can comprise a bi-directional force along the third direction y.

In some embodiments, the elastic member 13 is a component capable of providing an elastic force to the locking part 12. In some embodiments, the locking part 12 can provide an abutting force for the fixed pipe 20 in the accommodating cavity 110 under the action of the elastic member 13. In some other embodiments, the locking part 12 can provide a clamping force for the fixed pipe 20 in the accommodating cavity 110 under the action of the elastic member 13.

The elastic member 13 can include, but is not limited to, springs, elastic sheets, or other elastic structures that can provide elastic force.

In some embodiments, the triggering part 14 is a component connected to the locking part 12. A portion of the triggering part 14 is located outside the main body 11, thus making it easily accessible to the user for triggering. The function of the triggering part 14 includes the following. When triggered, the locking part 12 can be enabled to overcome the elastic force of the triggering part 14, thereby canceling the abutting or clamping of the fixed pipe 20.

In some embodiments, when the triggering part 14 is triggered, the sliding seat 10 can easily slide along the fixed pipe 20, or the sliding seat 10 can easily detach from the fixed pipe 20.

In the above solution, on one hand, the elastic force provided by the elastic member 13 allows the locking part 12 to abut a portion of the fixed pipe 20 located in the accommodating cavity 110 so as to lock the fixed pipe 20 in the accommodating cavity 110, thus achieving relative fixation between the sliding seat 10 and the fixed pipe 20 and enabling adaptation to fixed pipes 20 of different sizes. On the other hand, by arranging the triggering part 14 and arranging a portion of the triggering part 14 outside the main body 11, the user can trigger the triggering part 14 from outside the main body 11 to unlock the locking part, thereby enabling quick separation of the sliding seat 10 from the fixed pipe 20.

According to some embodiments of the present disclosure, with reference to FIGS. 2 and 3, the main body 11 is provided with a fitting part 15, wherein the fitting part 15 is arranged in the accommodating cavity 110. The locking part 12 is oppositely arranged to the fitting part 15 along the third direction y. The locking part 12 is configured to move toward the fitting part 15 under the action of the elastic force, so as to jointly clamp the fixed pipe 20 with the fitting part 15.

The fitting part 15 is a component configured to cooperate with the locking part 12.

In some embodiments, the fitting part 15 is a wall portion of the accommodating cavity 110. The locking part 12, under the action of elastic force, presses the fixed pipe 20 against the wall portion of the accommodating cavity 110 to lock the fixed pipe 20.

In some embodiments, the fitting part 15 is a component fixed to the wall portion of the accommodating cavity 110. The locking part 12 and the fitting part 15 are oppositely arranged along the third direction y. The fixed pipe 20 is located between the locking part 12 and the fitting part 15. Under the action of the elastic force, the locking part 12 presses the fixed pipe 20 against the fitting part 15 to lock the fixed pipe 20.

In some embodiments, the fixed pipe 20 is a circular pipe. The fitting part 15 can be arranged to correspond to the arc surface of the fixed pipe 20. In other words, the surface of the fitting part 15 that contacts the fixed pipe 20 is an arc surface.

In the above solution, by arranging the fitting part 15, the locking part 12 is enabled to move in one direction under the action of the elastic member 13 so as to jointly clamp the fixed pipe 20 with the fitting part 15. On one hand, this allows the fixed pipe 20 to be stably locked in the accommodating cavity 110, thus ensuring a stable relative positional relationship between the sliding seat 10 and the fixed pipe 20. On the other hand, since the locking part 12 moves in one direction, the locking structure of the sliding seat 10 for the fixed pipe 20 is simple, which can reduce the failure rate of the sliding seat 10 and improve the operational stability of the sliding seat 10.

According to some embodiments of the present disclosure, with reference to FIG. 3, the locking part 12 is positioned between the triggering part 14 and the fitting part 15 along the third direction y. The triggering part 14 includes a pull knob, wherein a portion of the pull knob is located inside the main body 11 to connect the locking part 12 and another portion of the pull knob is located outside the main body 11, which is configured to pull the locking part 12 away from the fitting part 15.

In some embodiments, along the third direction y, the triggering part 14, the locking part 12, and the fitting part 15 are sequentially arranged.

In some embodiments, the triggering part 14 includes a pull knob, wherein it can be understood that the triggering part 14 can move relative to the main body 11 along the third direction y. Thus, by pulling the triggering part 14, the locking part 12 can move in the direction away from the fitting part 15, thereby disengaging from the fixed pipe 20 to achieve unlocking.

In some embodiments, the triggering part 14 is threaded through the end portion of the main body 11 away from the fitting part 15 along the third direction y.

In the above solution, by arranging the locking part 12 between the triggering part 14 and the fitting part 15, and arranging the triggering part 14 to be included with a pull knob, the locking part 12 can be conveniently pulled away from the fitting part 15 by pulling the pull knob, thereby canceling the locking on the fixed pipe 20 and improving the efficiency of separating the sliding seat 10 from the fixed pipe 20.

In other embodiments, the triggering part 14 can also be a toggle button arranged on the peripheral surface of the main body 11, wherein the toggle button passes through the wall portion of the main body 11 and connects the locking part 12. By toggling the toggle button in the direction away from the fitting part 15, the locking part 12 can move in the direction away from the fitting part 15, thereby disengaging from the fixed pipe 20 to achieve unlocking.

In other embodiments, along the third direction y, the fitting part 15 is located between the triggering part 14 and the locking part 12. The triggering part 14 can be a button. By pressing the triggering part 14, the locking part 12 can move in the direction away from the fitting part 15, thereby disengaging from the fixed pipe 20 to achieve unlocking. In the embodiments, the triggering part 14 avoids the fitting part 15 to connect with the locking part 12, thereby pushing the locking part 12 to move in the direction away from the fitting part 15.

According to some embodiments of the present disclosure, with reference to FIG. 2 and FIG. 3, a sliding groove 111 is formed inside the main body 11, wherein the sliding groove 111 communicates with the accommodating cavity 110. The locking part 12 includes a sliding rod 120 and an abutting piece 121, wherein the triggering part 14 is connected to the sliding rod 120 and the sliding rod 120 can fit with the sliding groove 111 along the third direction y in a sliding manner. An end portion of the sliding rod 120 along the third direction y is connected to the abutting piece 121. The abutting piece 121 is configured to abut the fixed pipe 20.

The sliding groove 111 is a groove structure formed inside the main body 11. The sliding groove 111 is configured to cooperate with the locking part 12, thus allowing the locking part 12 to move along the third direction y under the guidance of the sliding groove 111.

In some embodiments, the sliding groove 111 can penetrate the main body 11 along the first direction z. The two opposite groove walls of the sliding groove 111 along the second direction x can be in sliding fit with the sliding rod 120 of the locking part.

In some embodiments, the locking part 12 includes a sliding rod 120 and an abutting piece 121. Optionally, the sliding rod 120 can be a block structure. The sliding rod 120 is configured to be in sliding fit with the sliding groove 111 so that the abutting piece 121 can abut or disengage from the fixed pipe 20 in the accommodating cavity 110.

In some embodiments, the abutting piece 121 is configured to press against the fixed pipe 20. When the fixed pipe 20 is a circular pipe, the surface of the abutting piece 121 that abuts the fixed pipe 20 can be an arc surface.

In the above solution, through the mutual cooperation of the sliding rod 120 and the sliding groove 111, the locking part 12 can stably move along the third direction y, so that the abutting piece 121 can stably abut against or move away from the fixed pipe 20. Thus, locking and unlocking of fixed pipe 20 is performed stably, making the sliding seat 10 highly reliable.

According to some embodiments of the present disclosure, with reference to FIG. 2, the sliding rod 120 includes a rod body 1200 and a slider 1201, wherein the slider 1201 is arranged on the outer periphery of the rod body 1200; and the slider 1201 is in sliding fit with the sliding groove 111. The groove wall of the sliding groove 111 is provided with a limiting block 1110 in a protruding manner. Along the third direction y, the limiting block 1110 is configured to contact the slider 1201 to prevent the sliding rod 120 from coming out of the sliding groove 111.

In some embodiments, along the third direction y, the end surface of the rod body 1200 facing the fitting part 15 is connected with the abutting piece 121. The slider 1201 is arranged at the end of the rod body 1200 away from the fitting part 15 and is located on the periphery of the rod body 1200. Optionally, two sliders 1201 are provided, wherein each of the two sliders 1201 corresponds to one of the two opposite groove walls of the sliding groove 111 along the second direction x.

The limiting block 1110 is a block structure arranged on the groove wall of the sliding groove 111. For example, the limiting block is arranged on the groove wall of the sliding groove 111 along the second direction x to contact the end surface of the slider 1201 facing the fitting part 15.

In the above solution, by providing a limiting block 1110 on the sliding groove 111 in a protruding manner to fit with the slider 1201, the sliding rod 120 can be prevented from coming out of the sliding groove 111 due to excessive movement. This results in high locking stability of the locking part 12, high reliability of the sliding seat 10, and stable connection between the sliding seat 10 and the fixed pipe 20.

According to some embodiments of the present disclosure, with reference to FIG. 3, along the third direction y, the end surface of the sliding rod 120 away from the fitting part 15 is provided with a groove 1202. The groove wall of the sliding groove 111 facing the sliding rod 120 is provided with a projection 1111. The elastic member 13 includes a spring, wherein one end of the spring is sleeved on the projection 1111, and the other end is accommodated in the groove 1202.

In some embodiments, the groove wall of the sliding groove 111 facing the sliding rod 120 is provided with a projection 1111. The triggering part 14 passes through the projection 1111 to connect with the sliding rod 120.

In some embodiments, the elastic member 13 is a spring, wherein one end of the spring is located in the groove 1202 of the sliding rod 120 and the other end of the spring is sleeved on the projection 1111.

In the above solution, by providing a groove 1202 on the end surface of the sliding rod 120 away from the fitting part 15 and arranging a projection 1111 on the groove wall of the sliding groove 111 facing the sliding rod 120, the elastic member 13 can stably provide elastic force along the third direction y to the sliding rod 120. This results in high locking stability of the locking part 12, high reliability of the sliding seat 10, and stable connection between the sliding seat 10 and the fixed pipe 20.

According to some embodiments of the present disclosure, with reference to FIG. 3, along the third direction y, the bottom of the groove 1202 is provided with a connecting piece 1203, wherein the triggering part 14 passes through the wall portion of the main body 11 and is in a threaded fit with the connecting piece 1203.

In some embodiments, the connecting piece 1203 can include a screw, wherein the outer periphery of the screw is provided with external threads. The triggering part 14 can include an end cover and a pull rod, wherein the end surface of the pull rod facing the connecting piece 1203 is provided with a threaded hole. The pull rod is in a threaded fit with the connecting piece 1203. By pulling the end cover, the user can pull the locking part away from the fitting part 15 to achieve unlocking.

In the above solution, by providing a connecting piece 1203 at the bottom of the groove 1202, on the one hand, the difficulty of assembling the triggering part 14 and the locking part 12 can be reduced, thus improving the manufacturing efficiency of the sliding seat 10. On the other hand, the connection part of the triggering part 14 and the locking part 12 can be hidden in the groove 1202, thereby reducing the impact of external substances on the connection part of the triggering part 14 and the locking part 12 and making the appearance of the sliding seat 10 tidy.

According to some embodiments of the present disclosure, the abutting piece 121 and the fitting part 15 are friction pads, respectively.

In some embodiments, the abutting piece 121 and the fitting part 15 are made of rubber material, and the mutually facing surfaces can be arranged with concave-convex structures to increase the friction with the fixed pipe 20.

In the above solution, by providing friction pads, the sliding seat 10 can be stably mounted on the fixed pipe 20, thereby reducing the risk of the sliding seat 10 sliding or detaching from the fixed pipe 20 due to impact.

According to some embodiments of the present disclosure, with reference to FIG. 2, the sliding seat 10 further includes a bracket set 16, wherein along the third direction y, the bracket set 16 is arranged at the end portion of the main body 11. The bracket set 16 is provided with a hanging-mounting hole 17, wherein the hanging-mounting hole 17 is configured for hanging and mounting workpieces.

In some embodiments, the bracket set 16 and the main body 11 are separate structures. The bracket set 16 can be fixed to the main body 11 by bolts. The bracket set 16 is provided with a hanging-mounting hole 17, wherein the hanging-mounting hole 17 penetrates along the first direction z and the hanging-mounting hole 17 is provided with an opening facing the third direction y. The workpiece can be a shower head 30, and the shower head 30 can move in and out of the hanging-mounting hole 17 along the third direction y.

In the above solution, by providing the bracket set 16, workpieces can be hung. Exemplarily, the workpiece is a shower head 30. By providing the bracket set 16, the shower head 30 can be mounted on the sliding seat 10.

According to some embodiments of the present disclosure, with reference to FIG. 1 to FIG. 3, the sliding seat 10 can also include a housing 18, wherein the housing 18 covers the main body 11. The housing 18 is provided with perforations corresponding to the accommodating cavity 110 to allow the fixed pipe 20 to enter, exit, and pass through.

According to some embodiments of the present disclosure, with reference to FIG. 4, a shower head assembly 100 is further provided, including a fixed pipe 20, a shower head 30, and the sliding seat 10 provided in the first aspect. The fixed pipe 20 is located in the accommodating cavity 110, the sliding seat 10 is fixed to the fixed pipe 20 through the locking part 12, and the shower head 30 is mounted on the sliding seat 10.

In the above solution, the fixed pipe 20 can be fixed to the wall, and the shower head 30 is mounted on the sliding seat 10. The sliding seat 10 can be stably mounted on the fixed pipe 20 through the cooperation of the locking part 12 and the elastic member 13, which can also adapt to the fixed pipes 20 of different sizes. At the same time, the sliding seat 10 is able to overcome the elastic force of the elastic member 13 by the triggering part 14, so as to quickly and easily remove the sliding seat 10 from the fixed pipe 20.

The above is only a preferred embodiment of the present disclosure, which is not intended to limit the present disclosure. The present disclosure may have various changes and variations for those skilled in the art. Any modification, equivalent substitution, improvement, etc. made within the spirit and principles of the present disclosure shall be included in the scope of protection of the present disclosure.

### INDUSTRIAL PRACTICALITY

The present disclosure provides a sliding seat. On one hand, the elastic force provided by the elastic member allows the locking part to abut a portion of the structural component (e.g., fixed pipe) located in the accommodating cavity so as to lock the structural component in the accommodating cavity, thus achieving relative fixation between the sliding seat and the structural component and enabling adaptation to structural components of different sizes. On the other hand, by arranging the triggering part and arranging a portion of the triggering part outside the main body, the user can trigger the triggering part from outside the main body to unlock the locking part, thereby enabling quick separation of the sliding seat from the structural component.

The present disclosure further provides a shower head assembly. The fixed pipe can be fixed to the wall, and the shower head is mounted on the sliding seat. The sliding seat can be stably mounted on the fixed pipe through the cooperation of the locking part and the elastic member, which can also adapt to fixed pipes of different sizes. At the same time, the sliding seat is able to overcome the elastic force of the elastic member by the triggering part, so as to quickly and easily remove the sliding seat from the fixed pipe.

Additionally, it is important to note that the sliding seat and the shower head assembly provided in the embodiments of the present disclosure are reproducible and applicable in various industrial applications. For example, the sliding seat and the shower head assembly provided by the embodiments of the present disclosure can be used in the technical field of kitchen and bathroom products.

What is claimed is:

1. A sliding seat, comprising
a main body, provided with an accommodating cavity that penetrates in a first direction, wherein the accommodating cavity is provided with an access opening arranged in a second direction; and the access opening allows a structural component to enter and exit the accommodating cavity;
a locking part, arranged in the accommodating cavity in a movable manner;
an elastic member, arranged on the main body and connected to the locking part, wherein the elastic member is configured to provide an elastic force to the locking part so that the locking part abuts the structural component in a third direction to lock the structural component in the accommodating cavity; and the first direction, the second direction, and the third direction are mutually perpendicular to each other; and
a triggering part, connected to the locking part, wherein a portion of the triggering part is located outside the main body, and the portion of the triggering part located outside the main body is configured to be triggered so that the locking part overcomes the elastic force and cancels the locking for the structural component.

2. The sliding seat according to claim 1, wherein
the main body is provided with a fitting part, wherein the fitting part is arranged in the accommodating cavity; the locking part is oppositely arranged to the fitting part along the third direction; and the locking part is configured to move toward the fitting part under an action of the elastic force, so as to jointly clamp the structural component with the fitting part.

3. The sliding seat according to claim 2, wherein
the locking part is located between the triggering part and the fitting part along the third direction; and
the triggering part comprises a pull knob, wherein a portion of the pull knob is located inside the main body to connect the locking part, and another portion of the pull knob is located outside the main body, and configured to pull the locking part away from the fitting part.

4. The sliding seat according to claim 2, wherein
a sliding groove is formed inside the main body, and the sliding groove communicates with the accommodating cavity; and
the locking part comprises a sliding rod and an abutting piece, wherein the triggering part is connected to the sliding rod and the sliding rod fits with the sliding groove along the third direction in a slidable manner; an end portion of the sliding rod along the third direction is connected to the abutting piece; and the abutting piece is configured to abut the structural component.

5. The sliding seat according to claim 4, wherein
the sliding rod comprises a rod body and a slider, wherein the slider is arranged on an outer periphery of the rod body, and the slider is in sliding fit with the sliding groove; and
a groove wall of the sliding groove is provided with a limiting block in a protruding manner, wherein along the third direction, the limiting block is configured to contact the slider to prevent the sliding rod from coming out of the sliding groove.

6. The sliding seat according to claim 4, wherein
along the third direction, an end surface of the sliding rod away from the fitting part is provided with a groove; a groove wall of the sliding groove facing the sliding rod is provided with a projection; and the elastic member comprises a spring, wherein one end of the spring is sleeved on the projection, and the other end is accommodated in the groove.

7. The sliding seat according to claim 6, wherein
along the third direction, a bottom of the groove is provided with a connecting piece, and the triggering part passes through a wall portion of the main body and is in a threaded fit with the connecting piece.

8. The sliding seat according to claim 4, wherein
the abutting piece and the fitting part are friction pads, respectively.

9. The sliding seat according to claim 1, wherein
the sliding seat further comprises a bracket set; along a third direction, the bracket set is arranged at an end portion of the main body; and the bracket set is provided with a hanging-mounting hole, wherein the hanging-mounting hole is configured for hanging and mounting workpieces.

10. The sliding seat according to claim 3, wherein
the triggering part moves relative to the main body along a third direction so that by pulling the triggering part, the locking part moves in a direction away from the fitting part.

11. The sliding seat according to claim 5, wherein
two sliders are provided, and each of the two sliders corresponds to one of two opposite groove walls of the sliding groove along the second direction.

12. A shower head assembly, comprising
a fixed pipe;
a shower head; and
the sliding seat according to claim 1, wherein the fixed pipe is located in the accommodating cavity; the sliding seat is fixed to the fixed pipe through the locking part; and the shower head is mounted on the sliding seat.

13. The shower head assembly according to claim 12, wherein
the fitting part is a wall portion of the accommodating cavity; and the locking part, under an action of elastic force, presses the fixed pipe against the wall portion of the accommodating cavity to lock the fixed pipe.

14. The shower head assembly according to claim 12, wherein
the fixed pipe is a circular pipe, and the fitting part is arranged to correspond to an arc surface of the fixed pipe.

15. The shower head assembly according to claim 12, wherein
the accommodating cavity penetrates in the first direction, thus allowing the sliding seat to slide relative to the fixed pipe along the first direction.

16. The shower head assembly according to claim 12, wherein
the accommodating cavity is provided with an opening arranged in the second direction, thus enabling the sliding seat to detach from the fixed pipe along the second direction or accommodate the fixed pipe in the accommodating cavity.

17. The shower head assembly according to claim 12, wherein
the locking part provides an abutting force for the fixed pipe in the accommodating cavity, thus ensuring that the fixed pipe remains stationary relative to the main body under an action of the abutting force; and the abutting force is a unidirectional force along the third direction.

18. The shower head assembly according to claim 12, wherein
the locking part provides a clamping force for the fixed pipe in the accommodating cavity, thus ensuring that the fixed pipe remains stationary relative to the main body under an action of the clamping force; and the clamping force comprises a bi-directional force along the third direction.

19. The shower head assembly according to claim 12, wherein
the sliding seat further comprises a housing; the housing covers the main body; and the housing is provided with perforations corresponding to the accommodating cavity to allow the fixed pipe to enter and exit and pass through.
